(19) United States
(12) Patent Application Publication
(10) Pub. No.: US 2010/0250483 A1
(43) Pub. Date: Sep. 30, 2010

(54) EFFECT PREDICTING APPARATUS, COMPUTER PROGRAM PRODUCT, AND METHOD FOR PREDICTING AN EFFECT

(75) Inventors: Tomoko Ohyama, Akashi-shi (JP); Masaki Shibayama, Kobe-shi (JP); Hideki Ishihara, Miki-shi (JP); Tomokazu Yoshida, Kobe-shi (JP); Keigo Gohda, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/569,130

(22) Filed: Sep. 29, 2009

(30) Foreign Application Priority Data
Mar. 27, 2009 (JP) 2009-080652

(51) Int. Cl. G06N 5/02

(52) U.S. Cl. 706/54

(57) ABSTRACT

An effect predicting apparatus for predicting an effect of anthracycline anticancer drugs, comprising: a display, a processor, and a memory, under control of said processor, including software instructions adapted to enable the processor to perform operations, comprising: acquiring a CDK parameter based on a first CDK parameter and a second CDK parameter; acquiring an expression level of glutathione; comparing the CDK parameter with a CDK threshold value, and the expression level of glutathione with a glutathione threshold value; predicting an effect of anthracycline anticancer drugs based on the result of the comparison; and displaying the result of the prediction. A computer program product and a method for predicting an effect are also disclosed.

### FIELD OF THE INVENTION

The present invention relates to an effect predicting apparatus for predicting an effect of an anthracycline anticancer drug, which is based on an activity value and an expression level of CDK and an amount of glutathione, and a method thereof.

### BACKGROUND

Conventionally, a method for predicting an effect of an anticancer drug treatment by using a cyclin-dependent kinase (also referred to hereinafter as “CDK”) has been proposed.

For example, JP-A 2007-6882 describes a method for predicting a susceptibility of a patient to an anticancer drug treatment, which includes comparing at least one parameter selected from the group consisting of an activity value of a cyclin-dependent kinase (CDK) contained in a tumor cell of a patient, an expression level of the CDK, and a ratio of the activity value to the expression level, with a threshold value for a selected parameter, and predicting the susceptibility of the patient to the anticancer drug treatment based on the result of the comparison.

However, for deciding on courses of treatment for the malignant tumor patient, a method of more reliably predicting the effect of an anticancer drug is necessary.

### SUMMARY OF THE INVENTION

The scope of the present invention is defined solely by the appended claims, and is not affected to any degree by the statements within this summary.

A first aspect of the present invention is an effect predicting apparatus for predicting an effect of anthracycline anticancer drugs, comprising: a display, a processor, and a memory, under control of said processor, including software instructions adapted to enable the processor to perform operations, comprising: acquiring a CDK parameter based on a first cyclin dependent kinase (first CDK) parameter and a second cyclin dependent kinase (second CDK) parameter, wherein the first CDK parameter is capable to be acquired from an activity value and an expression level of the first CDK, and the second CDK parameter is capable to be acquired from an activity value and an expression level of the second CDK, contained in a malignant tumor of a patient; acquiring an expression level of glutathione contained in a malignant tumor of the patient; comparing the CDK parameter with a CDK threshold value for a CDK parameter, and the expression level of glutathione with a glutathione threshold value for an expression level of glutathione; predicting an effect of anthracycline anticancer drugs for the patient based on the result of the comparison; and displaying the result of the prediction.

A second aspect of the present invention is a computer program product, comprising: a computer readable medium; and instructions, on the computer readable medium, adapted to enable a general purpose computer to perform operations, comprising: acquiring a CDK parameter based on a first cyclin dependent kinase (first CDK) parameter and a second cyclin dependent kinase (second CDK) parameter, wherein the first CDK parameter is capable to be acquired from an activity value and an expression level of the first CDK, and the second CDK parameter is capable to be acquired from an activity value and an expression level of the second CDK, contained in a malignant tumor of a patient; acquiring an expression level of glutathione contained in a malignant tumor of the patient; comparing the CDK parameter with a CDK threshold value for a CDK parameter, and the expression level of glutathione with a glutathione threshold value for an expression level of glutathione; predicting an effect of anthracycline anticancer drugs for the patient based on the result of the comparison; and displaying the result of the prediction.

A third aspect of the present invention is a method for predicting an effect of anthracycline anticancer drugs comprising the steps of: acquiring a CDK parameter based on a first cyclin dependent kinase (first CDK) parameter and a second cyclin dependent kinase (second CDK) parameter, wherein the first CDK parameter is capable to be acquired from an activity value and an expression level of the first CDK, and the second CDK parameter is capable to be acquired from an activity value and an expression level of the second CDK, contained in a malignant tumor of a patient; acquiring an expression level of glutathione contained in a malignant tumor of the patient; and predicting an effect of anthracycline anticancer drugs based on the CDK parameter and the expression level of glutathione.

### BRIEF DESCRIPTION OF THE DRAWINGS

FIG. 1 is a diagram showing one embodiment of an effect predicting apparatus for predicting an effect of an anthracycline anticancer drug;

FIG. 2 is a diagram showing a judgment flow of an effect predicting apparatus for predicting an effect of an anthracycline anticancer drug;

FIG. 3 is a table showing measured values in a group of patients in the past calculated in Example 1;

FIG. 4 is a distribution chart for analytes in which amounts of glutathione are shown in the abscissa and CDK specific activity ratios in the ordinate;

FIG. 5 is a graph showing a survival curve of subjects divided by CDK specific activity ratios into an anthracycline anticancer drug-susceptible group and an insusceptible group;

FIG. 6 is a graph showing a survival curve of subjects divided by an amount of glutathione into an anthracycline anticancer drug-susceptible group and an insusceptible group; and

FIG. 7 is a graph showing a survival curve of subjects divided by CDK specific activity ratios and amounts of glutathione into an anthracycline anticancer drug-susceptible group and an insusceptible group.

### DETAILED DESCRIPTION OF THE PREFERRED EMBODIMENTS

Hereinafter, a method for predicting an effect of an anthracycline anticancer drug according to the present invention and an effect predicting apparatus thereof will be described in detail with reference to the accompanying drawings.

[1] Method for Predicting an Effect of an Anthracycline Anticancer Drug

A malignant tumor of a patient may include, for example, those cells which among biological tissues of the patient, constitute supporting tissues such as a fibrous connective tissue, a cartilage tissue, a bone tissue, blood and lymph, as well as an epithelium tissue, a muscle tissue, and a nervous tissue. Particularly, cells used preferably in the judgment method in this embodiment are those cells from which pathological information is to be obtained, such as tumor cells in a tissue from an individual with a balance broken by dysfunctions ingrowth regulation. Preferable examples of such tumor cells include those cells derived from tumor cells generated in organs such as breast, lung, liver, stomach, colon, pancreas, skin, uterus, testis, ovary, thyroid gland, parathyroid gland, lymphatic system, and bone marrow.

The anthracycline anticancer drug refers to a group of antibiotics each having 1 to 3 amino acids or a neutral carbohydrate bound to anthracycline that is an aglycone. Examples of the anthracycline anticancer drug include daunorubicin, doxorubicin, aclarubicin, epirubicin, bleomycin, etc.

The cyclin-dependent kinase (CDK) refers generally to a group of enzymes to be activated by binding to cyclin. The CKD does not have an activity by itself, and upon binding to cyclin, becomes activated CDK. The CDK functions in a particular stage of cell cycle depending on the type thereof.

The CDK includes CDK1, CDK2, CDK4, CDK6, a cyclin A-dependent kinase, a cyclin D-dependent kinase and the like. First and second CDKs are determined from these CDKs described above, and the first and second CDKs of a malignant tumor of a patient are measured for their expression levels and active values, respectively.

An activity value of CDK is measured in terms of kinase activity level (unit: U) calculated from an amount of a substrate phosphorylated by binding to a specific cyclin. The substrate to be phosphorylated with the CDK includes, for example, histone 1 (H1) as a substrate phosphorylated with activated CDK1 and activated CDK2 and retinoblastoma protein (Rb) as a substrate phosphorylated with activated CDK4 and activated CDK6. The activity value of CDK can be measured by a conventional method of measuring CDK activity. Specifically, there is a method which includes preparing a sample containing activated CDK from a cell lysate of a measurement sample, then using the prepared sample and ³²P-labeled ATP (γ-[³²P]-ATP) so that a substrate protein is allowed to incorporate ³²P, measuring the labeling amount of the ³²P-labeled phosphorylated substrate, and quantitatively determining the activity level based on a standard curve previously prepared using standard samples. A method of measuring an activity value of CDK without using a radioactive label includes a method disclosed in U.S. Publication No. 2002/0164673.

The method disclosed in U.S. Publication No. 2002/0164673 is a method which includes preparing a sample containing objective activated CDK from a cell lysate as an analyte, reacting a substrate protein with adenosine 5′-O-(3-thiotriphosphate) (ATP-γS) to introduce a monothiophosphate group into a serine or threonine residue of the substrate protein, binding a fluorescent labeling substance or a labeled enzyme to a sulfur atom in the introduced monothiophosphate group thereby labeling the substrate protein, measuring an amount of the labeled thiophosphorylated substrate (or an amount of the fluorescent substance if the fluorescent labeling substance is used), and quantitatively determining the activity level based on a standard curve previously prepared using standard samples.

Samples to be subjected to activity measurement are prepared by collecting intended CDK specifically from lysates of tissues containing malignant tumors to be measured. In this case, the sample may be prepared by using an anti-CDK antibody specific to the intended CDK. When an activity of a specific cyclin-dependent kinase (e.g. a cyclin A-dependent kinase, a cyclin B-dependent kinase, or a cyclin E-dependent kinase) is measured, the sample may be prepared by using an anti-cyclin antibody specific to the cyclin-dependent kinase of interest. In either case, the sample contains CDK other than the activated CDK. The sample also contains e.g. conjugates having a CDK inhibitor bound to a cyclin/CDK conjugate. Also, when the anti-CDK antibody is used, the sample may contain CDK itself, CDK conjugates such as CDK-cyclin conjugates, CDK-CDK inhibitor conjugates, CDK-cyclin-CDK inhibitor conjugates, and conjugates of CDK and other compounds. Accordingly, the activity value is measured in terms of the unit (U) of the phosphorylated substrate under the condition where various CDKs such as activated CDK, inactivated CDK, and various competitive reactive substances coexist.

The CDK expression level is an amount of target CDK (unit corresponding to the number of molecules) contained in a cell lysate of tissue containing a malignant tumor to be measured, and can be measured by a conventional known method of measuring a mass of a target protein in a protein-containing mixture. For example, an enzyme-linked immunosorbent assay (ELISA) or a Western blot method may be used. Alternatively, a method disclosed in JP-A 2003-130871 may also be used for measuring. A target protein, i.e., CDK, may be captured by using an antibody specific to the target protein. For instance, an anti-CDK1 antibody can be used to capture all CDK1s occurring in cells, such as CDK itself, CDK-cyclin conjugates, CDK-CDK inhibitor conjugates, CDK-cyclin-CDK inhibitor conjugates, and conjugates of CDK and other compounds.

The first parameter is obtained from an activity value and an expression level of a first CDK, while the second parameter is obtained from an activity value and an expression level of a second CDK. As the parameter, either the activity value or the expression level may be solely used, or a value calculated by addition, subtraction, multiplication and division of the activity value and the expression level may be used, but a ratio between the activity value and the expression level is preferably used. As the ratio between the activity value and the expression level, the activity value divided by the expression level (activity value/expression level=specific activity) or the expression level divided by the activity value (expression level/activity value=reciprocal of specific activity), or the like, can be used.

The CDK parameter can be a value calculated by addition, subtraction, multiplication and division of the first and second parameters, but is preferably the ratio between the first parameter and the second parameter. The ratio between the first parameter and the second parameter may be either the first parameter divided by the second parameter or the second parameter divided by the first parameter.

The glutathione parameter is a parameter obtained from an amount of glutathione of a malignant tumor of a patient. A method of measuring the amount of glutathione may be a generally known method, for example a method using a kit such as Glutathione Assay Kit (Calbiochem).

Specifically, a reaction substrate 4-chloro-1-methyl-7-trifluoromethyl-quinolinium methylsulfate reacts with mercaptan derivatives such as glutathione to form mercaptan-conjugated thioethers. Among these thioethers, only glutathione-conjugated thioether undergoes elimination reaction under alkaline conditions to form thione. The absorption wavelength of thione formed is 400 nm, and from this absorbance, an amount of thione is quantified to calculate the amount of glutathione contained in the sample.

Glutathione is a tripeptide made of glycine, cystine and glutamic acid, and is regarded as including in regulation of cellular functions by radical trapping and oxidoreduction. For example, glutathione is involved in detoxification wherein harmful substances in the body are bound to glutathione (glutathione conjugation) followed by cutting glutamic acid and glycine thereby being excreted as mercapturic acid.

For the relationship between glutathione and prediction of an effect of an anthracycline anticancer drug, the following two mechanisms have been suggested.

(1) An anthracycline anticancer drug is known to give oxidative stress to cells thereby exhibiting a cell-killing effect, and glutathione is considered to reduce this cell-killing effect.
(2) An anthracycline anticancer drug is considered to undergo glutathione conjugation thereby being excreted extracellularly.

From the mechanisms described above, it is suggested that an amount of determined glutathione can serve as an indicator of the effect of an anthracycline anticancer drug.

In a step of judging susceptibility to an anthracycline anticancer drug, the susceptibility to an anthracycline anticancer drug is judged by comparing the CDK parameter and the glutathione parameter with previously established threshold values.

The threshold value is a value established appropriately depending on a type of anticancer drug and a type of cancer. Specifically, when the presence or absence of the susceptibility to an anthracycline anticancer drug is judged, CDK parameters are calculated for those cancer cells which among cancer cells of a plurality of patients, are known to recur or not to recur after extirpative surgery. The threshold value can be a value which among the calculated values, can distinguish between a patient group in which a treatment with an anthracycline anticancer drug is effective and a patient group in which a treatment with an anthracycline anticancer drug is not effective. The threshold value for the glutathione parameter can be similarly established.

Highly reliable prediction of an effect of an anticancer drug treatment becomes possible in this manner by establishing a threshold value based on actual clinical treatment results.

[2] An Effect Predicting Apparatus for Predicting an Effect of an Anthracycline Anticancer Drug

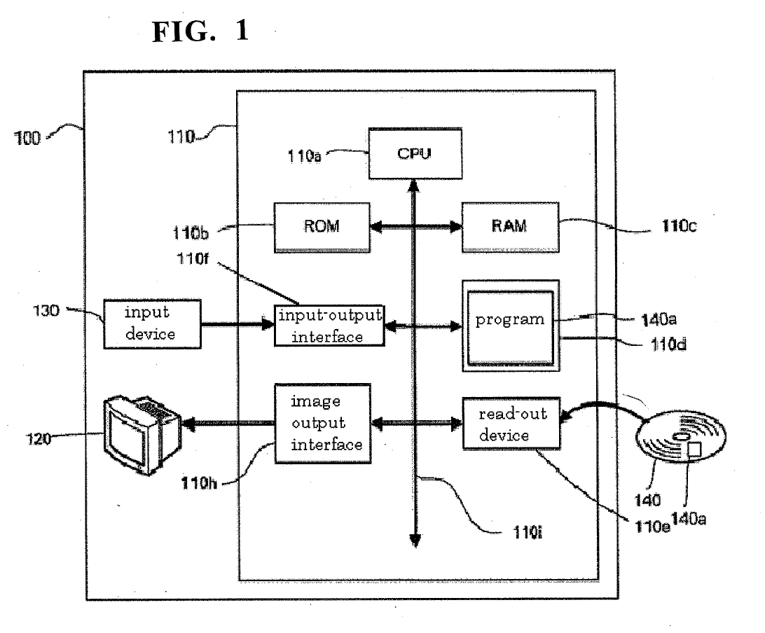

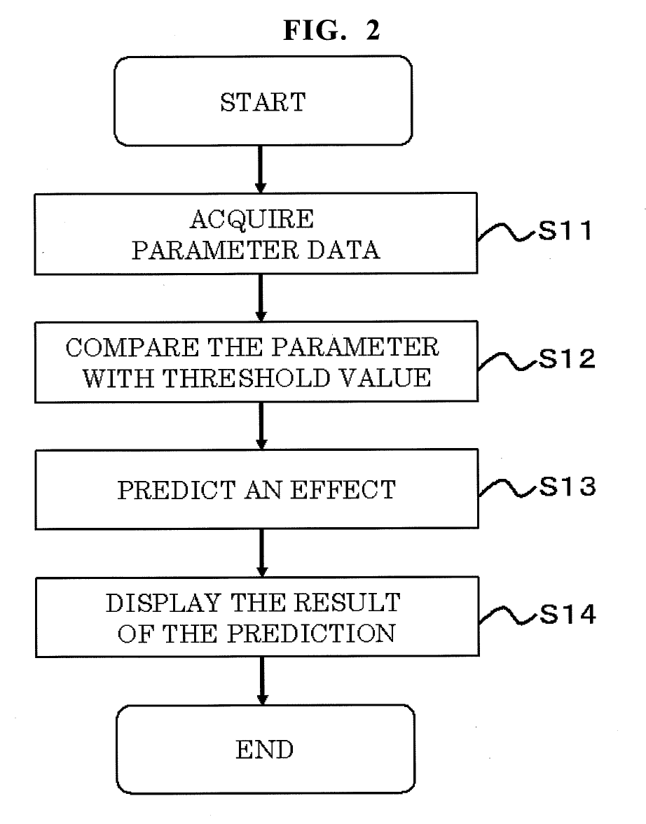

Hereinafter, an effect predicting apparatus (FIG. 1) in one embodiment for predicting an effect of an anthracycline anticancer drug according to the present invention, and a judgment flow (FIG. 2) therefor, will be described in detail.

An effect predicting apparatus 100 shown in FIG. 1 includes a computer body 110, an input device 130 for entering necessary data to the computer body 110, and a display 120 for displaying input-output data etc. The effect predicting apparatus 100 can further include an external recording medium 140 if necessary. A program 140a in this embodiment may be recorded on the external recording medium 140. Alternatively, the program 140a may be stored in memories 110b to 110d installed in the computer body 110. CPU 110a, memories 110b to 110d, an input-output interface 110f, an image output interface 110h, and a read-out device 110e are connected to one another via bus 110i in the computer body 110 such that data can be transmitted and received.

FIG. 2 is a flowchart showing a working of a program for executing prediction of an effect of an anthracycline anticancer drug. This program is stored in the memory 110d.

First, expression level of CDK1, activity value of CDK1, expression level of CDK2, and activity value of CDK2 are acquired from a measurement apparatus for measuring an expression levels and activity values. The measurement apparatus calculates the CDK2 specific activity/CDK1 specific activity from the expression level of CDK1, the activity value of CDK1, the expression level of CDK2, and the activity value of CDK2

The CDK2 specific activity/CDK1 specific activity (also referred to hereinafter as CDK specific activity ratio) and an amount of glutathione, of a malignant tumor of a patient, when entered by the input device 130, are sent by the CPU 110a via the input-output interface 110f to RAM 110c where the parameter data are memorized (step S11).

In the embodiment described above, the parameter data are acquired from the measurement apparatus, but the present invention is not limited to this embodiment. For example, expression level of CDK1, activity value of CDK1, expression level of CDK2, and activity value of CDK2 may be inputted via the input device 130, and the CPU 110a may caluculate the CDK specific activity ratio from the inputted value, thereby acquiring the parameter data.

The CPU 110a calls up a threshold value for CDK2 specific activity/CDK1 specific activity (also referred to hereinafter as CDK specific activity ratio) and a threshold value for glutathione amount, both of which are previously memorized as program data in the memory 110d. Comparison between these threshold values and the parameter data is executed (step S12).

Based on the comparison result, the CPU 110a then predicts an effect of an anthracycline anticancer drug (step S13). The CPU 110a determines that when the CDK specific activity ratio is higher than the threshold value and simultaneously the amount of glutathione is equal to or lower than the threshold value, then the patient is “susceptible” to the anthracycline anticancer drug.

When the CDK specific activity ratio is higher than the threshold value and simultaneously the amount of glutathione is higher than the threshold value or when the CDK specific activity ratio is equal to or lower than the threshold value and simultaneously the amount of glutathione is higher than the threshold value, or when the CDK specific activity ratio is equal to or lower than the threshold value and simultaneously the amount of glutathione is equal to or lower than the threshold value, then the patient is predicted to be “insusceptible” to the anthracycline anticancer drug.

Then, the CPU 110a allows the above prediction result to be stored in the RAM 110c and simultaneously outputted to the display 120 via the image output interface 110h (step S14).

Hereinafter, the present invention will be described in detail with reference to examples, but the present invention is not limited thereto.

### Example 1

### Method for Predicting an Effect of an Anthracycline Anticancer Drug

20 cases of breast tumor tissues were obtained as analytes from patients in the past. These 20 cases are those from patients who had administered with anthracycline anticancer drugs for chemotherapy after collection of the analytes, and are those from the patients known to undergo, or not to undergo, cancer recurrence after administration.

(1) Preparation of Measurement Samples

20 analytes of tumor cell mass obtained from 20 breast cancer patients (patients 1 to 20) who had received treatment with anthracycline anticancer drugs were used to prepare measurement samples 1 to 20 in the following procedures.

First, a buffer solution A (0.1 w/v % Nonidet P-40 (Calbiochem), 50 mM Tris-HCl (pH 7.4), 5 mM EDTA, 50 mM sodium fluoride, 1 mM sodium orthovanadate, and 100 μL/mL protease inhibitor cocktail) and the tumor cell mass were placed in a tube so that the tumor cell mass in the buffer solution was approximately 150 mg/mL.

The tumor cell mass was homogenized in the buffer solution A with an electric homogenizer and disrupted the tumor cell mass to prepare a cell lysate. Then, the cell lysate was centrifuged at 15,000 rpm at 4° C. for 5 minutes, to give a supernatant for use as the measurement sample.

(2) Measurement of Expression Levels of CDK1 and CDK2

50 μl of each measurement sample was put in each well of a blotter with a PVDF membrane (Millipore) set thereon. Then, the measurement sample was suctioned from a bottom surface of the well, that is, a rear surface of the membrane, at a negative pressure of approximately 250 mmHg for approximately 30 seconds so that a protein in the measurement sample was adsorbed to the membrane. 100 μL of a washing solution B (25 mM Tris-HCl (pH 7.4) and 150 mM NaCl) was put in each well and suctioned at a negative pressure of 500 mmHg for 15 seconds, thereby washing the membrane. After washing, 40 μL of a blocking reagent B (4% BSA, 25 mM Tris-HCl (pH 7.4) and 150 mM NaCl) was put in each well and left in a stationary state for 15 minutes, and each well was suctioned at a negative pressure of 500 mmHg for 15 seconds, thereby blocking the membrane.

After blocking, 40 μl, of a rabbit anti-CDK1 antibody (first antibody) solution to be specifically bound to the CDK1 was put in each well and left in a stationary state at room temperature for approximately 30 minutes so that the CDK1 and the first antibody in the membrane were reacted with each other. Then, the bottom surface of the well was suctioned at a negative pressure of 500 mmHg for 15 seconds. 100 μL of the washing solution B was put in each well which was then suctioned at a negative pressure of 500 mmHg for 15 seconds, thereby washing the membrane. 40 μL of a biotinylated anti-rabbit IgG-B antibody (second antibody) solution was put in each well and left in a stationary state at room temperature for approximately 30 minutes so that the first antibody was reacted with second antibody in the membrane. Thereafter, the bottom surface of the well was suctioned at a negative pressure of 500 mmHg for 15 seconds. 100 μL of the washing solution B was put in each well which was then suctioned at a negative pressure of 500 mmHg for 15 seconds, thereby washing the membrane. 50 μL of a labeled solution containing FITC-labeled streptavidin was put in each well and left in a stationary state at room temperature for 30 minutes so that the second antibody in the membrane was FITC-labeled. Thereafter, the bottom surface of the well suctioned at a negative pressure of 500 mmHg for 15 seconds.

50 μL of the washing solution B was put in each well which was then suctioned at a negative pressure of 500 mmHg for 15 seconds; this operation was repeated 5 times so that the membrane was washed.

The membrane was detached from the blotter, rinsed with 20% methanol for 5 minutes and dried at room temperature for 20 minutes. Thereafter, the protein adsorbed to the membrane was analyzed and measured for its fluorescence intensity with a fluorescence image analyzer. The measurement value was calculated based on a calibration curve.

The calibration curve was prepared in the following manner: 50 μL of a solution obtained by dissolving recombinant CDK1 at five different concentrations in a washing solution B (containing 0.005% Nonidet P-40 and 50 μg/mL BSA) was put to each well treated previously in the same manner as described above, and then labeled with FITC in the same experimental procedure as described above, followed by measuring the fluorescence intensity thereof, thereby expressing the relationship between the fluorescence intensity and an expression level of CDK1.

An expression level of CDK2 was determined in the same experimental procedure as described above in determination of the expression level of CDK1 except that a rabbit anti-CDK2 antibody was used as the first antibody in place of the rabbit anti-CDK1 antibody.

(3) Measurement of Activities of CDK1 and CDK2

500 μL of the buffer A was put in a 1.5-ml Eppendorf tube, and the measurement sample was added thereto. The measurement sample was added to the tube such that the total protein mass in the resulting mixed solution in the tube reached 100 μg. 2 μg of the anti-CDK1 antibody and 20 μL of Sepharose beads coated with protein A were add thereto and left in a stationary state at 4° C. for 1 hour so that the CDK1 and the anti-CDK1 antibody were reacted with each other. After the reaction, the beads were washed 3 times with a beads washing buffer (containing 0.1 w/v % Nonidet P-40 and 50 mM Tris-HCl (pH 7.0)) and then suspended again in 15 μL of the lysis buffer A, whereby a sample containing Sepharose beads to which CDK1 was bound via the anti-CDK1 antibody was obtained.

10 μg of a CDK1 substrate solution (containing 10 μg histone H1, 5 mM ATP-γS (Sigma), 20 mM Tris-HCl (pH 7.4) and 0.1% Triton X-100) was added to the sample. The substrate solution was added to the tube such that the total amount of the mixed solution in the tube reached 50 μL. The mixture was shaken at 37° C. for 10 minutes to cause a kinase reaction, thereby introducing a monothiophosphoric acid group into the histone H1.

After the kinase reaction, the reaction mixture was centrifuged at 2,000 rpm for 20 seconds to precipitate the beads, thereby recovering 18 μL of a supernatant. 15 μL of a binding buffer (containing 150 mM Tris-HCl (pH 9.2) and 5 mM EDTA) and 10 mM iodoacetylbiotin solution (containing 100 mM Tris-HCl (pH 7.5) and 1 mM EDTA) were added to the supernatant and left in a stationary state at room temperature in a dark place for 90 minutes, whereby the iodoacetylbiotin was bound to a sulfuric atom of the substrate (monothiophosphoric acid substrate) into which the monothiophosphoric acid group had been introduced. The reaction of the iodoacetylbiotin with the monothiophosphoric acid group was terminated by adding 2-melcaptoethanol. A sample containing 0.4 μg of the monothiophosphoric acid substrate to which the iodoacetylbiotin had been bound was blotted onto the PVDF membrane by means of a slot blotter.

The PVDF membrane was blocked with a solution containing 1 w/v % BSA, and streptavidin-FITC (Vector Laboratories) was added thereto, and the mixture was reacted at 37° C. for 1 hour. After the reaction, the PVDF membrane was washed 3 times with 50 mM washing solution B. After the washing, the PVDF membrane was analyzed for its fluorescence with a fluorescence image analyzer. The activity value was calculated based on a calibration curve.

The calibration curve was prepared in the following manner: Solutions containing a protein (biotin-labeled immunoglobulin) at 2 different concentrations were blotted onto the PVDF membrane which was then FITC-labeled in the same manner as described above, and the fluorescence intensities of the protein were measured with the fluorescence image analyzer. Accordingly, 1 U (unit) activity of CDK1 to be measured refers to that activity which shows fluorescence intensity equal to that when the protein is 1 ng.

An activity value of CDK2 was measured in the same manner as for an activity value of CDK1 except that the anti-CDK2 antibody was used in place of the anti-CDK1 antibody.

(4) Calculation of CDK specific activities and CDK2 specific activity/CDK1 specific activity Ratio (CDK Specific Activity Ratio)

From the CDK activity values and the CDK expression levels measured above, a CDK1 specific activity and a CDK2 specific activity (mU/ng) were calculated according to the following equation:

CDK specific activity=CDK activity value/CDK expression level

Then, a CDK2 specific activity/CDK1 specific activity ratio (CDK specific activity ratio) was calculated from the CDK1 and CDK2 specific activities obtained.

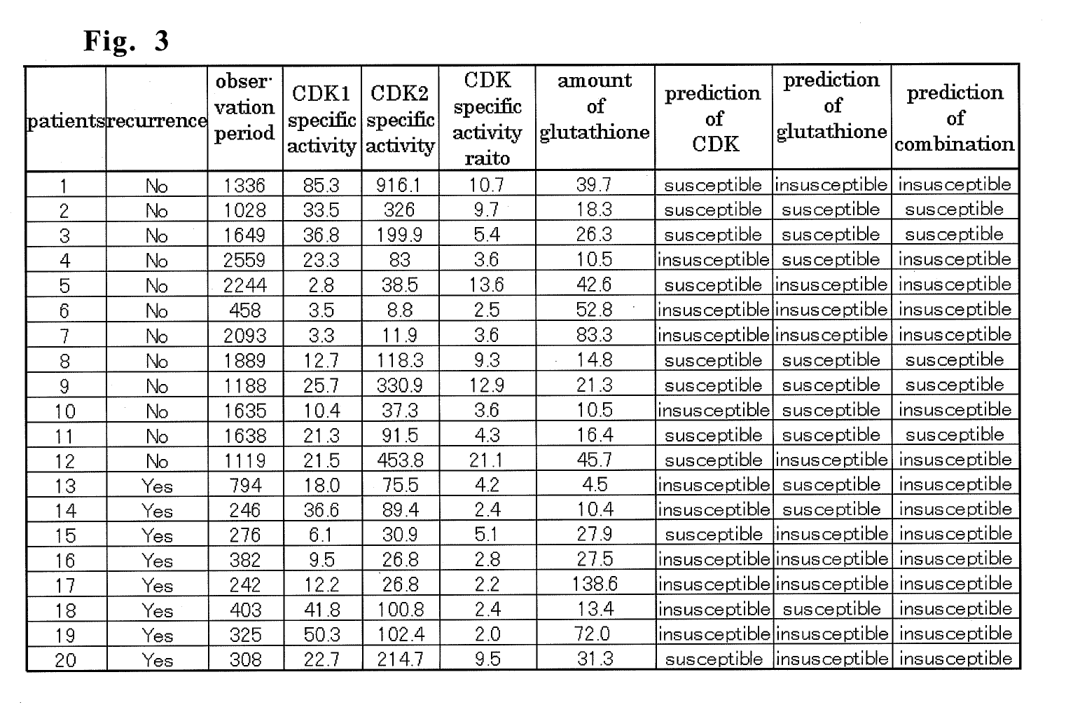

The CDK1 and CDK2 specific activities and the CDK2 specific activity/CDK1 specific activity ratio thus obtained are shown in FIG. 3.

(5) Calculation of an Amount of Glutathione

Using a glutathione assay kit (Cat. No. 354102, Calbiochem), an amount of glutathione was calculated according to the following method.

(1) Buffer A (0.1 w/v % Nonidet P-40 (Calbiochem), 50 mM Tris-HCl (pH 7.4), 5 mM EDTA, 50 mM sodium fluoride, 1 mM sodium orthovanadate, and 100 μl/ml protease inhibitor cocktail) was added to tumor cell mass such that the tumor cell mass in the buffer reached about 150 mg/mL.
(2) 5% Metaphosphoric acid was added to 150 μg (20 to 300 μL) of the tissue cell mass in the buffer such that the final volume became 900 μL.
(3) An insoluble fraction was removed by centrifugation (3000×G, 4° C., 10 minutes), and its supernatant was recovered for use as a sample.
(4) Solution R1 attached to the commercial kit mentioned above was added to and mixed with the sample in (3).
(5) Solution R2 attached to the commercial kit mentioned above was added to and mixed with the sample in (4).
(6) The mixture was left at room temperature for 10 minutes under shading, and then measured for its absorbance at a wavelength of 400 nm.
(7) A calibration curve was prepared, from which the amount of glutathione was calculated. The calibration curve was prepared by using 6 glutathione solutions prepared at different concentrations ranging from 0 to 100 μmol/L. This calibration curve was used to calculate a concentration of glutathione in the sample, that is, the amount of glutathione.

The amounts of glutathione (unit: μg/L) thus obtained are shown in item glutathione in the table.

(6) Establishment of Threshold Values and Prediction of an Effect of Anthracycline Anticancer Drug

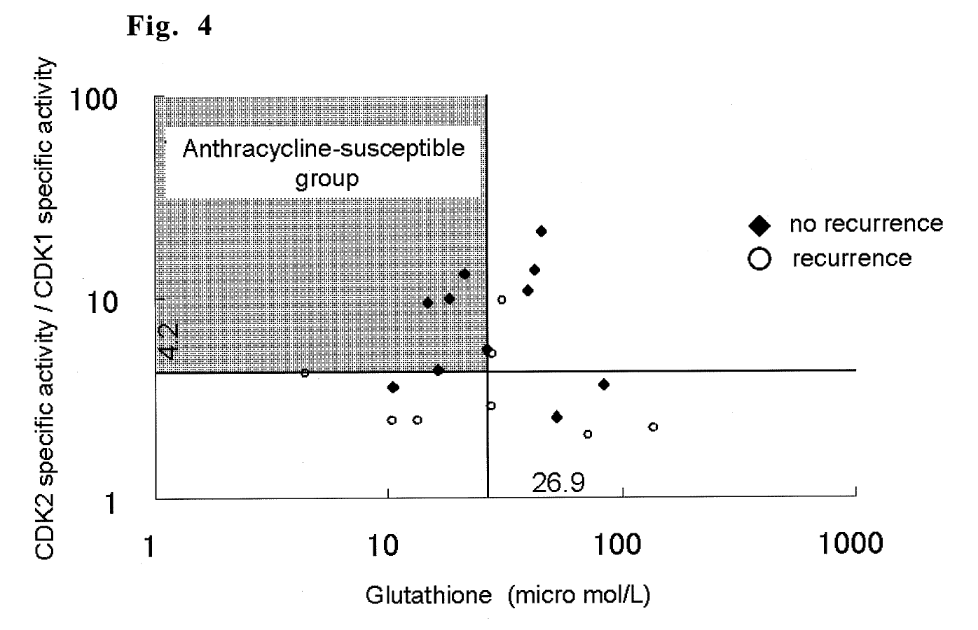

FIG. 3 is a table showing the values obtained by the methods described above. FIG. 4 is a distribution chart (double logarithmic plot) based on the numerical values in FIG. 3 in which for the respective analytes, the amounts of glutathione are shown in the abscissa and the CDK specific activity ratio in the ordinate.

In FIG. 4, the respective analytes are divided into 4 groups according to threshold values established according to variables that are the CDK specific activity ratio and the amount of glutathione. Herein, the threshold value for the CDK specific activity ratio was 4.2, and the threshold value for the amount of glutathione was 26.9.

In FIG. 4, it is estimated that when the CDK specific activity ratio in an analyte is higher than the threshold value, the analyte is anthracycline-susceptible. When the amount of glutathione in an analyte is lower than the threshold value, the analyte is estimated to be anthracycline-susceptible. Accordingly, when the CDK specific activity ratio is higher than the threshold value, and simultaneously the amount of glutathione is lower than the threshold value, the analyte can be judged with the highest accuracy to be in an anthracycline-susceptible group. The susceptibility to the anthracycline anticancer drugs can be divided into 4 classes in this manner by tabulating the CDK specific activity ratios and the amounts of glutathione in a group of patients in the past.

Accordingly, the CDK specific activity ratio and the amount of glutathione in a malignant tumor of a patient are measured by the methods described above, and the obtained values are compared in the distribution chart shown above, thereby making it possible to judge whether the patient is susceptible or insusceptible to anthracycline anticancer drugs.

From the foregoing, it is revealed that when the result of comparison between the CDK specific activity ratio and its threshold value is combined with the result of comparison between the amount of glutathione and its threshold value, the susceptibility to anthracycline anticancer drugs can be classified into 4 different groups, and an effect of anthracycline anticancer drugs can thus be predicted. Further, this prediction result can be an indicator in deciding on courses of treatment for the malignant tumor patient.

### Example 2

### Verification of Prediction of an Effect of Anthracycline Anticancer Drugs by the CDK Specific Activities and the Amount of Glutathione

For verification of prediction of an effect of anthracycline anticancer drugs, cumulative recurrence probability between two classified groups (that is, an anthracycline anticancer drug-susceptible group and an insusceptible group) was analyzed by the Kaplan Meier method. In this verification, the 20 cases in FIG. 3 prepared in Example 1 were used in analysis, and the threshold values in Example 1 were used in classification thereof into a susceptible group and an insusceptible group.

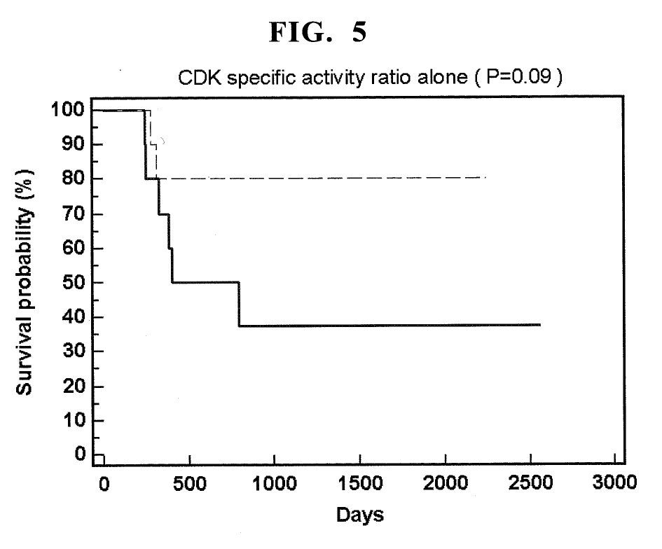

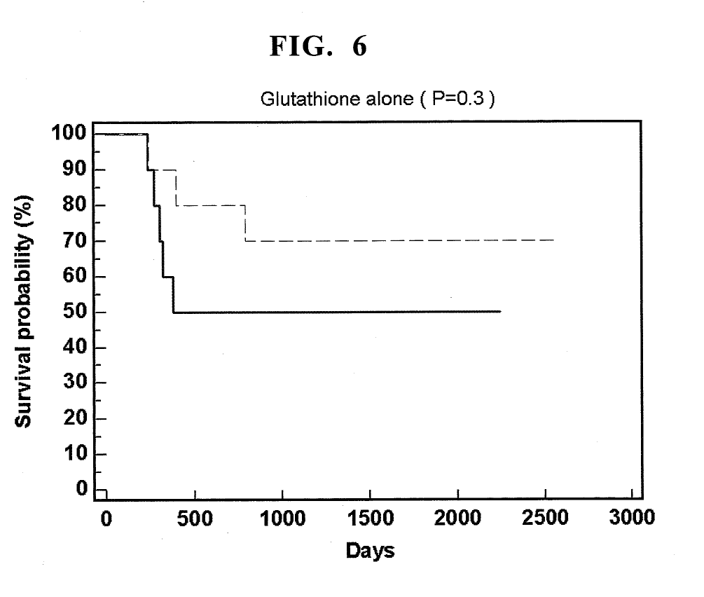

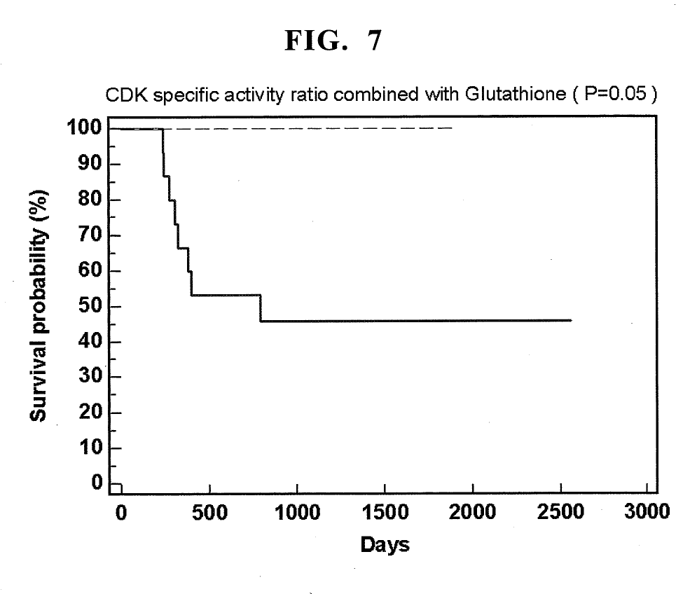

A survival curve obtained by the Kaplan Meier method after the classification, by only the CDK specific activity ratios, into an anthracycline anticancer drug-susceptible group and an insusceptible group is shown in FIG. 5. Similarly, a survival curve obtained by classification by only the amounts of glutathione is shown in FIG. 6, and a survival curve obtained by classification both by the CDK specific activity ratios and by the amounts of glutathione is shown in FIG. 7. The solid line indicates an anthracycline anticancer drug-insusceptible group, the broken line indicates an anthracycline anticancer drug-susceptible group, and the P value shows significance probability between the two groups in a logrank test.

### Results

The analysis of susceptibility both by the CDK specific activity ratios and by the amounts of glutathione (FIG. 7), rather than the analysis of susceptibility by only the CDK specific activity ratios (FIG. 5) or the analysis by only the amounts of glutathione (FIG. 6), showed a significantly higher cumulative survival rate in the group predicted to be a susceptible group than in the group predicted to be an insusceptible group. From this result, the analysis by the CDK specific activity ratio and the amount of glutathione can predict the effect of anticancer drug more accurately than by the conventional analysis of only the CDK specific activity ratio, and it was suggested that anthracycline anticancer drugs are effective for patients appearing in the upper left region in FIG. 4 in Example 1.

What is claimed is:

1. An effect predicting apparatus for predicting an effect of anthracycline anticancer drugs, comprising:
a display,
a processor, and
a memory, under control of said processor, including software instructions adapted to enable the processor to perform operations, comprising:
acquiring a CDK parameter based on a first cyclin dependent kinase (first CDK) parameter and a second cyclin dependent kinase (second CDK) parameter, wherein the first CDK parameter is capable to be acquired from an activity value and an expression level of the first CDK, and the second CDK parameter is capable to be acquired from an activity value and an expression level of the second CDK, contained in a malignant tumor of a patient;
acquiring an expression level of glutathione contained in a malignant tumor of the patient;
comparing the CDK parameter with a CDK threshold value for a CDK parameter, and the expression level of glutathione with a glutathione threshold value for an expression level of glutathione;
predicting an effect of anthracycline anticancer drugs for the patient based on the result of the comparison; and displaying the result of the prediction.

2. The apparatus of claim 1, wherein the operations comprise:
in cancer patients who after excision of malignant tumors, were administered with anthracycline anticancer drugs, comparing a CDK parameters and a expression levels of glutathione in the malignant tumors excised from the cancer patients, with information on recurrence in the cancer patients after excision of the malignant tumors, thereby memorizing threshold values capable of dividing the cancer patients into at least 2 groups different in a risk of recurrence.

3. The apparatus of claim 1, wherein the first parameter is a first CDK specific activity.

4. The apparatus of claim 1, wherein the second parameter is a second CDK specific activity.

5. The apparatus of claim 1, wherein the CDK parameter is a ratio between the first parameter and the second parameter.

6. The apparatus of claim 1, wherein the operations comprise:
a first comparison step of comparing the CDK parameter with a first threshold value and a second comparison step of comparing the expression level of glutathione with a second threshold value.

7. The apparatus of claim 6, wherein the operations comprise:
judging the subject to be anthracycline-susceptible when the CDK parameter is higher the first threshold value and the expression level of glutathione is lower than the second threshold value, as a result of the first and second comparison steps.

8. A computer program product, comprising:
a computer readable medium; and
instructions, on the computer readable medium, adapted to enable a general purpose computer to perform operations, comprising:
acquiring a CDK parameter based on a first cyclin dependent kinase (first CDK) parameter and a second cyclin dependent kinase (second CDK) parameter, wherein the first CDK parameter is capable to be acquired from an activity value and an expression level of the first CDK, and the second CDK parameter is capable to be acquired from an activity value and an expression level of the second CDK, contained in a malignant tumor of a patient;
acquiring an expression level of glutathione contained in a malignant tumor of the patient;
comparing the CDK parameter with a CDK threshold value for a CDK parameter, and the expression level of glutathione with a glutathione threshold value for an expression level of glutathione;
predicting an effect of anthracycline anticancer drugs for the patient based on the result of the comparison; and
displaying the result of the prediction.

9. The computer program product of claim 8, further comprising:
in cancer patients who after excision of malignant tumors, were administered with anthracycline anticancer drugs, comparing a CDK parameters and a expression levels of glutathione in the malignant tumors excised from the cancer patients, with information on recurrence in the cancer patients after excision of the malignant tumors, thereby memorizing threshold values capable of dividing the cancer patients into at least 2 groups different in a risk of recurrence.

10. The computer program product of claim 8, wherein the first parameter is a first CDK specific activity.

11. The computer program product of claim 8, wherein the second parameter is a second CDK specific activity.

12. The computer program product of claim 8, wherein the CDK parameter is a ratio between the first parameter and the second parameter.

13. The computer program product of claim 8, further comprising:
a first comparison step of comparing the CDK parameter with a first threshold value and a second comparison step of comparing the expression level of glutathione with a second threshold value.

14. The computer program product of claim 13, wherein the judging the subject to be anthracycline-susceptible when the CDK parameter is higher the first threshold value and the expression level of glutathione is lower than the second threshold value, as a result of the first and second comparison steps.

15. A method for predicting an effect of anthracycline anticancer drugs comprising:
acquiring a CDK parameter based on a first cyclin dependent kinase (first CDK) parameter and a second cyclin dependent kinase (second CDK) parameter, wherein the first CDK parameter is capable to be acquired from an activity value and an expression level of the first CDK, and the second CDK parameter is capable to be acquired from an activity value and an expression level of the second CDK, contained in a malignant tumor of a patient;
acquiring an expression level of glutathione contained in a malignant tumor of the patient; and
predicting an effect of anthracycline anticancer drugs based on the CDK parameter and the expression level of glutathione.

16. The method of claim 15, wherein the first parameter is a first CDK specific activity.

17. The method of claim 15, wherein the second parameter is a second CDK specific activity.

18. The method of claim 15, wherein the CDK parameter is a ratio between the first parameter and the second parameter.

19. The method of claim 15, further comprising
a first comparison step of comparing the CDK parameter with a first threshold value and a second comparison step of comparing the expression level of glutathione with a second threshold value.

20. The method of claim 19, wherein the judgment step is carried out by judging the subject to be anthracycline-susceptible when the CDK parameter is higher the first threshold value and the expression level of glutathione is lower than the second threshold value, as a result of the first and second comparison steps.
